(19) United States
(12) Patent Application Publication
(10) Pub. No.: US 2026/0109300 A1
(43) Pub. Date: Apr. 23, 2026

(54) MODULAR VIDEO PLATFORM APPARATUS

(71) Applicant: Charles Hirsch, Arlington, TX (US)

(72) Inventor: Charles Hirsch, Arlington, TX (US)

(21) Appl. No.: 19/221,768

(22) Filed: May 29, 2025

Related U.S. Application Data
(60) Provisional application No. 63/710,155, filed on Oct. 22, 2024.

(51) Int. Cl. B60R 9/06

(52) U.S. Cl. CPC B60R 9/06

(57) ABSTRACT

A three-dimensional reconfigurable framework apparatus, and moreover a three-dimensional reconfigurable vehicle mounting system, having a first group A column supports, a second group A column supports, at least one group C row supports, at least one coupling elements, at least one group B arcuate column supports having an arc angle θ, and at least one group D row supports that are rotatively interconnected to form the three-dimensional reconfigurable framework having at least a first position and a second position, wherein at least one movable attachment mechanism is arranged to vary a radial separation distance R between the at least one group C row supports and the at least one group D row supports.

### CROSS-REFERENCE TO RELATED APPLICATIONS

This application claims priority to U.S. Application No. 63/710155, filed Oct. 22, 2024, the contents of which are herein incorporated by reference in its entirety.

### FEDERALLY SPONSORED RESEARCH AND DEVELOPMENT

N/A

### JOINT RESEARCH AGREEMENT

N/A

### BACKGROUND OF THE INVENTION

This application relates to apparatus and systems for a movable three-dimensional reconfigurable framework and moreover a three-dimensional reconfigurable vehicle mounting system.

### SUMMARY OF THE INVENTION

The following provides a summary of certain exemplary embodiments of the present invention. This summary is not an extensive overview and is not intended to identify key or critical aspects or elements of the present invention or to delineate its scope. However, it is to be understood that the use of indefinite articles in the language used to describe and claim the present invention is not intended in any way to limit the described apparatus, methods, or systems. Rather the use of “a” or “an” should be interpreted to mean “at least one” or “one or more”.

In accordance with one general aspect of the present invention, a three-dimensional reconfigurable framework is provided. The three-dimensional reconfigurable framework includes a first group A column support; and a second group A column support; and at least one group C row support; and at least one coupling element; wherein the first group A column support is rotatively connected to at least one coupling element; and the second group A column support is rotatively connected to at least one coupling element; and the at least one group C row support is removably connected to both the first group A column support and the second group A column support via at least one coupling element; and at least one group B arcuate column support; and at least one movable attachment mechanism; and the at least one group B arcuate column support cooperates with the at least one group C row support via at least one coupling element; and at least one group D row support; and the at least one group D row support is removably connected via at least one coupling element to the at least one group B arcuate column support; wherein each of the first group A column support, the second group A column support, the at least one group C row support, the at least one coupling elements, the at least one group B arcuate column support, and the at least one group D row support are rotatively interconnected to form a three-dimensional reconfigurable framework having at least a first position and a second position; and wherein in a first position the first group A column support and the second group A column support are both securely rotated into a mutually orthogonal arrangement with respect to the at least one group C row support; and in a second position the first group A column support and the second group A column support are both securely rotated into a mutually parallel arrangement with respect to the at least one group C row support; and in the first position the at least one group B arcuate column support is arcuate along a longest axis having an arc angle θ, wherein θ is in a range from about 2 degrees to about 60 degrees between a first end portion of the at least one group B arcuate column support and a second end portion of the at least one group B arcuate column support; and the first end portion of the at least one group B arcuate column support is orthogonal with respect to at least one group D row support; and the second end portion of the at least one group B arcuate column support is movably attached to the at least one group C row support through the at least one movable attachment mechanism; and wherein the at least one movable attachment mechanism is arranged to vary a radial separation distance R between the at least one group C row support and the at least one group D row support.

In accordance with a second aspect of the present invention, the three-dimensional reconfigurable framework includes wherein the at least one movable attachment mechanism is slidably attached along the longest axis of the at least one group B arcuate column support such that the at least one movable attachment mechanism is bidirectionally movable, at least in part, along a surface the second end portion of the at least one group B arcuate column support.

In accordance with a third aspect of the present invention, the three-dimensional reconfigurable framework includes wherein the three-dimensional reconfigurable framework further comprises a plurality of group B arcuate column supports each arcuate along respective longest axes and having arc angles θ, and a plurality of movable attachment mechanisms.

In accordance with a fourth aspect of the present invention, the three-dimensional reconfigurable framework includes wherein in the first position the first group A column support and the second group A column support are both securely rotatable by release of a manipulable locking mechanism; and in the second position the first group A column support and the second group A column support are both securely held in position by engagement of the manipulable locking mechanism.

In accordance with a fifth aspect of the present invention, the three-dimensional reconfigurable framework includes wherein the first group A column support and the second group A column support further comprise telescoping columns and feet.

In accordance with a sixth aspect of the present invention, the three-dimensional reconfigurable framework includes wherein the three-dimensional reconfigurable framework is constructed, at least in part, from materials having transmittance in the visible light spectrum characterized by transparency, translucence, chromaticity, monochromaticity, or polychromatic.

In accordance with a seventh aspect of the present invention, the three-dimensional reconfigurable framework includes wherein the three-dimensional reconfigurable framework further comprises one or more arrays of illuminators such that the one or more arrays of illuminators are removably enclosed within the three-dimensional reconfigurable framework.

In accordance with a eighth aspect of the present invention, the three-dimensional reconfigurable framework includes wherein the one or more arrays of illuminators are selected from the group consisting of monochromatic illuminators, polychromatic illuminators, and sequentially arranged combinations thereof.

In accordance with a ninth aspect of the present invention, a three-dimensional reconfigurable vehicle mounting system comprises a first group A column support; and a second group A column support; and at least one group C row support; and at least one coupling element; wherein the first group A column support is rotatively connected to at least one coupling element; and the second group A column support is rotatively connected to at least one coupling element; and the at least one group C row support is removably connected to both the first group A column support and the second group A column support via at least one coupling element; and at least one group B arcuate column support; and at least one movable attachment mechanism; and the at least one group B arcuate column support cooperates with the at least one group C row support via at least one coupling element; and at least one group D row support; and the at least one group D row support is removably connected via at least one coupling element to the at least one group B arcuate column support; wherein each of the first group A column support, the second group A column support, the at least one group C row support, the at least one coupling elements, the at least one group B arcuate column support, and the at least one group D row support are rotatively interconnected to form a three-dimensional reconfigurable vehicle mounting system having at least a first position and a second position; and wherein in a first position the first group A column support and the second group A column support are both securely rotated into a mutually orthogonal arrangement with respect to the at least one group C row support; and in a second position the first group A column support and the second group A column support are both securely rotated into a mutually parallel arrangement with respect to the at least one group C row support; and in the first position the at least one group B arcuate column support is arcuate along a longest axis having an arc angle θ, wherein θ is in a range from about 2 degrees to about 60 degrees between a first end portion of the at least one group B arcuate column support and a second end portion of the at least one group B arcuate column support; and the first end portion of the at least one group B arcuate column support is orthogonal with respect to at least one group D row support; and the second end portion of the at least one group B arcuate column support is movably attached to the at least one group C row support through the at least one movable attachment mechanism; and wherein the at least one movable attachment mechanism is arranged to vary a radial separation distance R between the at least one group C row support and the at least one group D row support; and wherein in the first position the three-dimensional reconfigurable vehicle mounting system is removably suspended over the tailgate of a vehicle, such that the first group A column support and the second group A column support are arranged adjacent to one face of the tailgate of a vehicle and the at least one group B arcuate column support is suspended adjacent to an opposite face of the tailgate of a vehicle.

In accordance with a tenth aspect of the present invention, a three-dimensional reconfigurable vehicle mounting system includes wherein the at least one movable attachment mechanism is slidably attached along the longest axis of the at least one group B arcuate column support such that the at least one movable attachment mechanism is bidirectionally movable, at least in part, along a surface the second end portion of the at least one group B arcuate column support.

In accordance with a eleventh aspect of the present invention, a three-dimensional reconfigurable vehicle mounting system includes wherein the three-dimensional reconfigurable vehicle mounting system further comprises a plurality of group B arcuate column supports each arcuate along respective longest axes and having arc angles θ, and a plurality of movable attachment mechanisms.

In accordance with a twelfth aspect of the present invention, a three-dimensional reconfigurable vehicle mounting system includes wherein in the first position the first group A column support and the second group A column support are both securely rotatable by release of a manipulable locking mechanism; and in the second position the first group A column support and the second group A column support are both securely held in position by engagement of the manipulable locking mechanism.

In accordance with a thirteenth aspect of the present invention, a three-dimensional reconfigurable vehicle mounting system includes wherein the first group A column support and the second group A column support further comprise telescoping columns and feet.

In accordance with a fourteenth aspect of the present invention, a three-dimensional reconfigurable vehicle mounting system includes wherein the three-dimensional reconfigurable vehicle mounting system is constructed, at least in part, from materials having transmittance in the visible light spectrum characterized by transparency, translucence, chromaticity, monochromaticity, or polychromatic.

In accordance with a fifteenth aspect of the present invention, a three-dimensional reconfigurable vehicle mounting system includes wherein the three-dimensional reconfigurable vehicle mounting system further comprises one or more arrays of illuminators such that the one or more arrays of illuminators are removably enclosed within the three-dimensional reconfigurable vehicle mounting system.

In accordance with a sixteenth aspect of the present invention, a three-dimensional reconfigurable vehicle mounting system includes wherein the one or more arrays of illuminators are selected from the group consisting of monochromatic illuminators, polychromatic illuminators, and sequentially arranged combinations thereof.

In accordance with a seventeenth aspect of the present invention, a three-dimensional reconfigurable vehicle mounting system includes wherein in the first position at least one length of the three-dimensional reconfigurable vehicle mounting system suspended over the tailgate of a vehicle is adjustable to accommodate a plurality of vehicle tailgate form factors.

In accordance with a eighteenth aspect of the present invention, a three-dimensional reconfigurable vehicle mounting system includes wherein the second end portion of the at least one group B arcuate column support is formed to receive a mounting bracket.

In accordance with a ninteenth aspect of the present invention, a three-dimensional reconfigurable vehicle mounting system includes wherein one or more tables are formed for attachment to at least one group B arcuate column supports.

Embodiments of the invention may include one or more of the following features. These features may be used singly, or in combination with each other.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a perspective view of a movable three-dimensional reconfigurable framework in accordance with an exemplary embodiment.

FIG. 2 is another perspective view of a three-dimensional reconfigurable framework in accordance with an exemplary embodiment.

FIG. 3 is a side view of a three-dimensional reconfigurable framework in accordance with an exemplary embodiment.

FIG. 4 is another view of a three-dimensional reconfigurable framework having a plurality of Group B arcuate columns in accordance with an exemplary embodiment.

FIG. 5 is another perspective view of a three-dimensional reconfigurable framework in various configurations in accordance with an exemplary embodiment.

FIG. 6 is a view of a three-dimensional reconfigurable framework in a second position in accordance with an exemplary embodiment.

FIG. 7 is a view of a manipulable locking mechanism of a three-dimensional reconfigurable framework in accordance with an exemplary embodiment.

FIG. 8 shows arrays of illuminators enclosed in a three-dimensional reconfigurable framework in accordance with embodiments.

FIG. 9 is a view of a three-dimensional reconfigurable vehicle mounting system in accordance with embodiments.

FIG. 10 is a view of a three-dimensional reconfigurable framework formed to receive mounting brackets in accordance with an exemplary embodiment.

FIG. 11 is another view of a three-dimensional reconfigurable vehicle mounting system formed to receive tables in accordance with an exemplary embodiment.

### DETAILED DESCRIPTION OF THE INVENTION

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

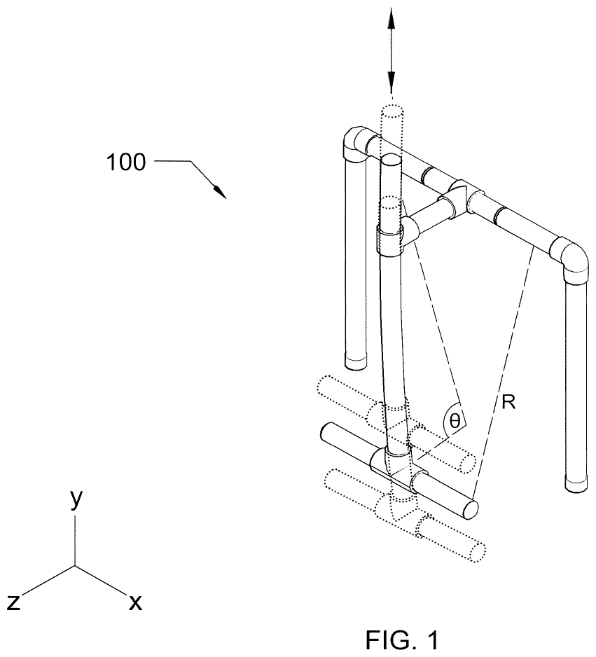

Referring to FIGS. 1-6, 8, 10, and 11 various views of a three-dimensional reconfigurable framework 100, 200, 300 are shown.

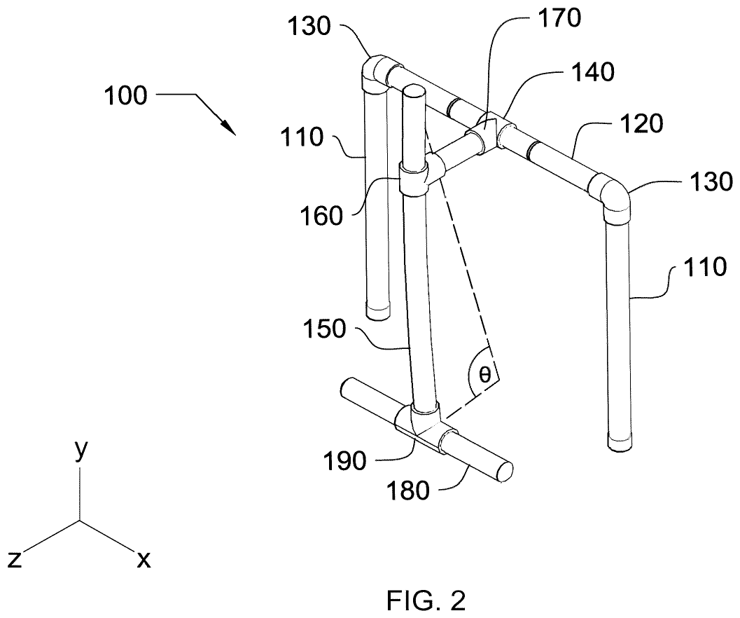

Referring to FIGS. 1 and 2, perspective views of a movable three-dimensional reconfigurable framework 100 in accordance with an exemplary embodiment is shown. As used herein Group A column supports include at least the first and second column supports 110 as shown. In a first position as shown, for example in FIGS. 1-5, the Group A column supports 110 are vertically arranged along a rearward portion of the three-dimensional reconfigurable framework 100. The Group A column supports 110 are structural support members and may include supporting beams, pillars, shafts, posts, stanchions, braces, crossbars, struts, cantilevers, etc. The Group A column supports 110 may be formed of a single solid material throughout, a set of layered materials, or a group of materials which are selectively combined to achieve desired characteristics including anticorrosive, antirust, scratch resistant, waterproof, resistant to discoloration, resistant to fading, lightweight, a desired degree of flexion, a desired degree of rigidity, etc. In some embodiments, the Group A column supports 110 may be formed of piping, poles, tubes, conduits, raceways, or hollow cylinders having one or more internal channels either concentric or otherwise. The Group A column supports 110 may be formed as airtight, watertight, or hermetically sealed.

The three-dimensional reconfigurable framework 100 also includes at least one Group C row supports 120. As used herein Group C row supports 120 in a first position are shown, for example in FIGS. 1-5. The Group C row supports 120 are horizontally arranged along a rearward portion of the three-dimensional reconfigurable framework 100. The Group C row supports 120 may be formed of the same materials, layers or group of materials as the Group A column supports 110. Additionally, the Group C row supports 120 may include any or all the characteristic structures described for the Group A column supports 110.

The three-dimensional reconfigurable framework 100 also includes at least one coupling element 130, 140, 190. The at least one coupling element 130, 140, 190 may include any mechanical junction element that may be used to connect the ends of adjacent parts such as the Group A column supports 110 and Group C row supports 120, etc. Exemplary mechanical couplings as are known in the art may be used as the at least one coupling element 130, 140, 190 such as junctions, sleeves, flanged, reducers, fittings, threaded or unthreaded, male or female, sealed or unsealed, angled, elbows, T-shaped, and of various materials including galvanized, black pipe, plastics, PVC, stainless steel, etc.

In a first position as shown in FIGS. 1-5, the first group A column supports 110 and the second group A column supports 110 are rotatively connected to at least one coupling element 130, 140, 190. One or more manipulable locking mechanisms 170, 175 are configured for manual release of connected elements. For example, the first group A column supports 110 and the second group A column supports 110 may be released for rotation by manual activation of one or more manipulable locking mechanisms 170, 175. Exemplary manipulable locking mechanisms 170, 175 may include a pushbutton, a lever, a toggle, a switch, a slider, a compressible coil, a tensioned spring, etc. The one or more manipulable locking mechanisms 170, 175 may be disengaged to release the connected elements or engaged to securely lock the connected elements into a reversably fixed position, thus securely held in place. Upon release of the manipulable locking mechanisms 170, 175, the connected first group A column supports 110 and the second group A column supports 110 may be manually rotated at least 90 degree from a first fully extended position for operation to a second fully collapsed position, e.g., for storage or transport. The manipulable locking mechanisms 170, 175, when disengaged, thus allow the connected first group A column supports 110 and the second group A column supports 110 to rotate from a first position to a second position or in the reverse direction.

Referring again to FIGS. 1-5, is shown at least one group B arcuate column supports 150. As used herein at least one group B arcuate column supports 150 in a first position are shown in FIGS. 1-5. The at least one group B arcuate column supports 150 are substantially vertically arranged along a frontward portion of the three-dimensional reconfigurable framework 100. The at least one group B arcuate column supports 150 may be formed of the same materials, layers or group of materials as the Group A column supports 110 as described above. Additionally, the at least one group B arcuate column supports 150 may include any or all the characteristic structures described for the Group A column supports 110.

As shown, the at least one group B arcuate column supports 150 cooperates with the at least one group C row supports 120 via at least one coupling element 130, 140, 190. In a first position, e.g., a fully extended position, the at least one group B arcuate column supports 150 is arcuate along a longest axis. The at least one group B arcuate column supports 150 has an arc angle θ, wherein θ is in a range from about 2 degrees to about 60 degrees between a first end portion, which is a lower portion of the at least one group B arcuate column supports 150, and a second end portion, which is an upper portion of the at least one group B arcuate column supports 150.

As best shown in FIG. 1, a radial separation distance R is defined between the at least one group C row supports 120 and the at least one group D row supports 180. In operation, the at least one movable attachment mechanism 160 is arranged to vary the radial separation distance R between the at least one group C row supports 120 and the at least one group D row supports 180 as the arc angle θ varies in a range from about 2 degrees to about 60 degrees. As a result, a height dimension of the three-dimensional reconfigurable framework 100 is variable along at least a Y axis and a width dimension of the three-dimensional reconfigurable framework 100 is simultaneously variable along at least a Z axis as the arc angle θ varies. Therefore the three-dimensional reconfigurable framework 100 is simultaneously variable along at least two orthogonal dimensions.

Returning now to FIG. 2, at least one group D row supports 180 is connected to the first end portion, which is the lower portion of the at least one group B arcuate column supports 150. The at least one group D row supports 180 are substantially horizontally arranged along a frontward portion of the three-dimensional reconfigurable framework 100. The at least one group D row supports 180 may be formed of the same materials, layers, or group of materials as the Group A column supports 110 as described above. Additionally, the at least one group D row supports 180 may include any or all the characteristic structures described for the Group A column supports 110. As shown in a first position, which is a fully extended position, the lower first end portion of the at least one group B arcuate column supports 150 is orthogonal with respect to at least one group D row supports 180, and is removably connected thereto via at least one coupling element 190. In addition, an upper second end portion of the at least one group B arcuate column supports 150 is movably attached to the at least one group C row supports 120 through at least one movable attachment mechanism 160.

The at least one movable attachment mechanism 160 includes a mechanical junction element that may be used to movably connect the at least one group B arcuate column supports 150 to at least one group C row supports 120. Exemplary mechanical junction elements as are known in the art may be used as the movable attachment mechanism 160 such as collars, loops, hoops, rings, junctions, sleeves, fittings, etc., constructed of various materials including galvanized, black pipe, plastics, PVC, stainless steel, etc. Importantly, the at least one movable attachment mechanism 160 is a sliding mechanical junction element.

In the first position, which is fully extended, the at least one movable attachment mechanism 160 is slidably attached along the longest axis of the at least one group B arcuate column supports 150 such that the at least one movable attachment mechanism is bidirectionally movable, at least in part, along a surface the second end portion of the at least one group B arcuate column supports 150.

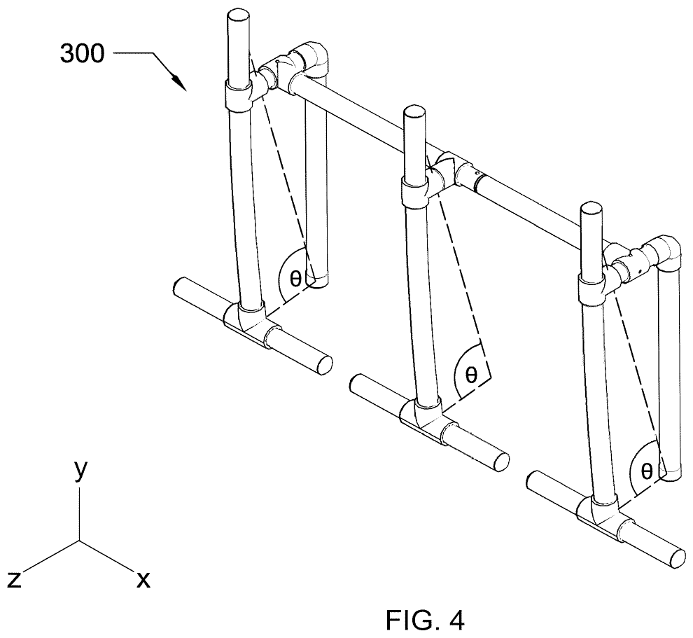

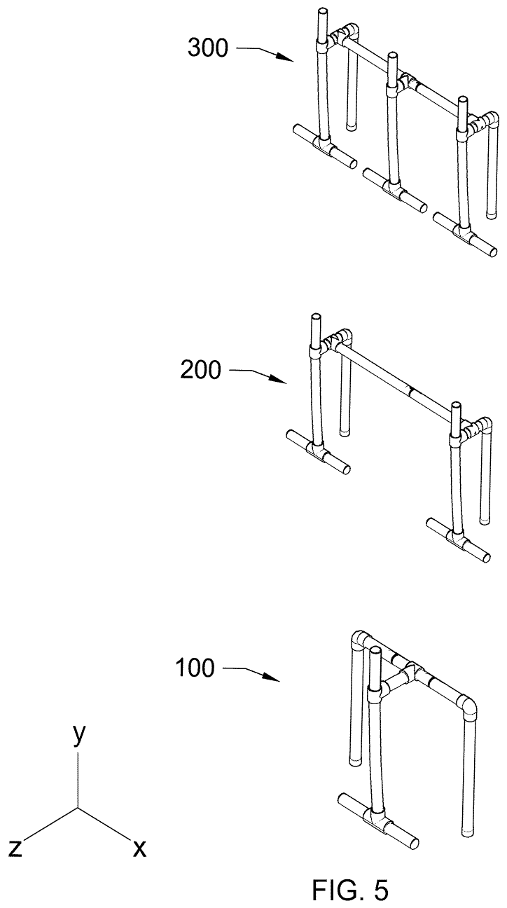

Moreover, as shown for example in FIGS. 4 and 5, the three-dimensional reconfigurable frameworks 200, 300 may further comprise a plurality of group B arcuate column supports 150 each arcuate along respective longest axes and having arc angles θ, and a plurality of movable attachment mechanisms 160.

The FIGS. 1-5 show a three-dimensional reconfigurable framework 100 having at least a first fully extended position wherein each of the first group A column supports 110, the second group A column supports 110, the at least one group C row supports 120, the at least one coupling elements 130, 140, 190, the at least one group B arcuate column supports 150, and the at least one group D row supports 180 are rotatively interconnected to form the three-dimensional reconfigurable framework 100. Each of the Group A column 110, Group B arcuate column 150, Group C row 120, Group D row 180 supports may be reconfigured to form any of the three-dimensional reconfigurable frameworks 100, 200, or 300 as shown in FIG. 5.

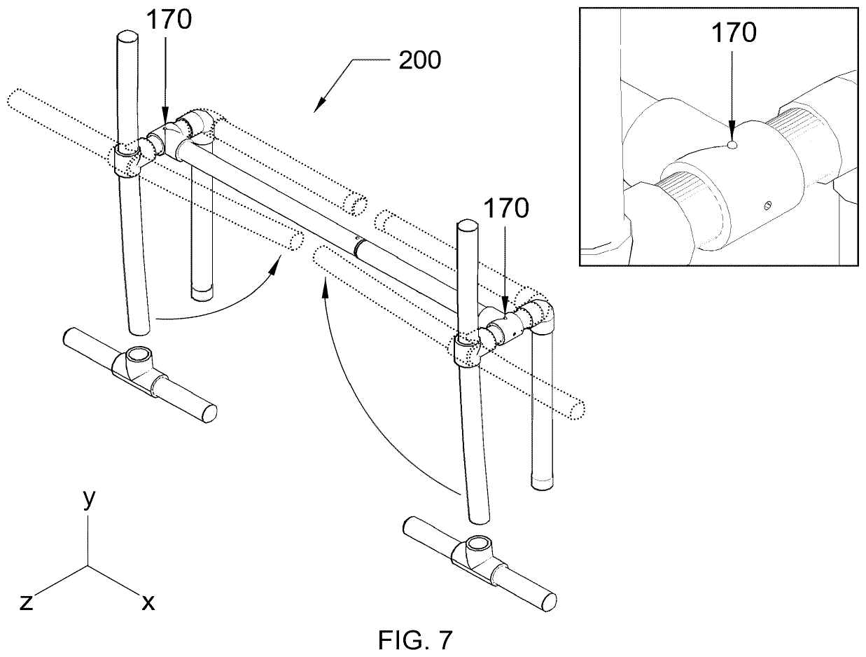

Referring now to FIG. 7 is a view of a manipulable locking mechanism of a three-dimensional reconfigurable framework in accordance with an exemplary embodiment. In an exemplary embodiment as shown, reconfiguration may be achieved by manual activation of the one or more manipulable locking mechanisms 170, 175 to disengage and release the connected support elements or to engage and securely lock the connected support elements into a reversably fixed position such that they are again securely held in place.

Therefore, by reconfigurable manual manipulations each of the three-dimensional reconfigurable frameworks 100, 200, or 300 as shown in FIG. 5 may be erected.

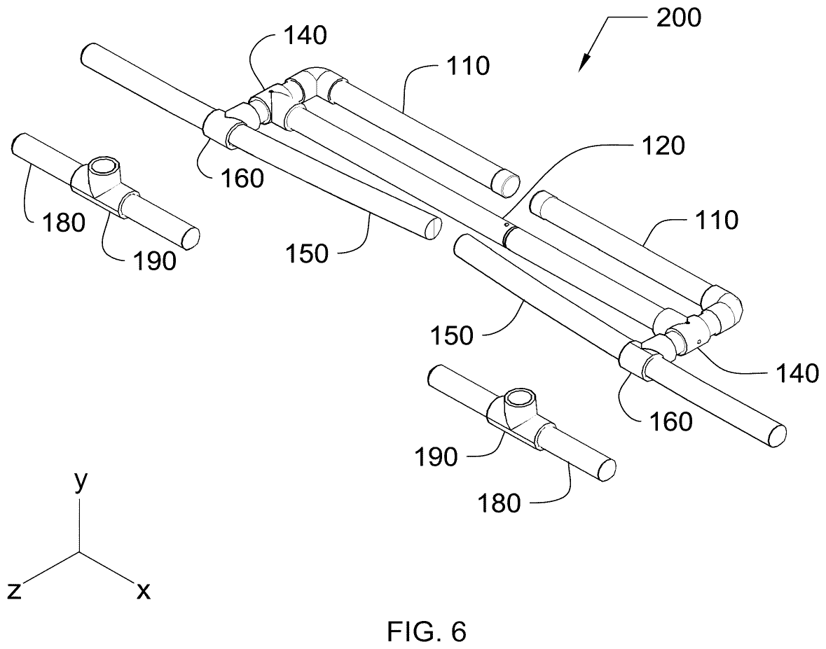

FIG. 6 shows a three-dimensional reconfigurable framework 200 having at least a second fully collapsed position.

In FIG. 6, in a second position, the first group A column supports 110 and the second group A column supports 110 are both securely rotated into a mutually parallel arrangement with respect to the at least one group C row supports 120. Similarly, the at least one movable attachment mechanism 160 is rotated. Therefore, a second position is a second fully collapsed position. The second position facilities ease of storage or transport of the three-dimensional reconfigurable framework 200.

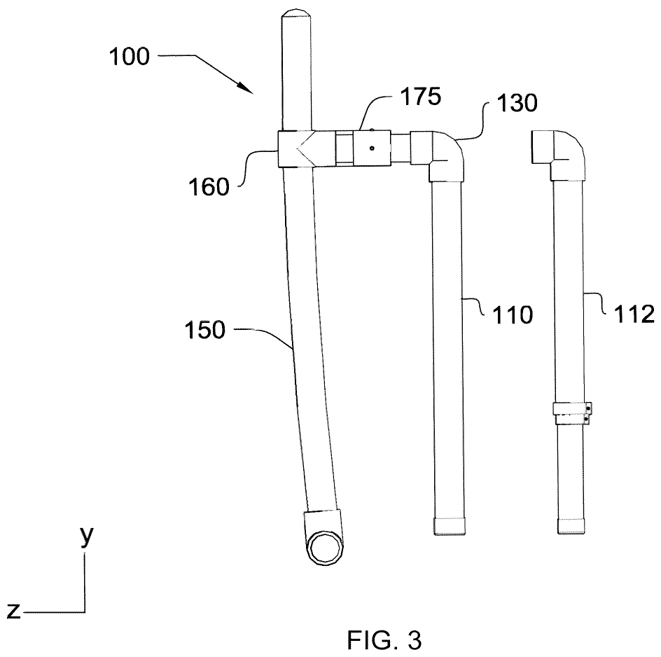

In some embodiments, for example as shown in FIG. 3, the first group A column supports 110 and the second group A column supports 110 may comprise one or more group A column supports that are telescoping group A column supports 112. Moreover, any group A column supports 110 or 112 may further include feet portions for enhanced stability under load.

In some embodiments, the three-dimensional reconfigurable frameworks 100, 200, or 300 as shown in FIGS. 1-11 may be constructed, at least in part, from a variety of materials including materials having a characteristic of transmittance within the electromagnetic spectrum, including the visible light spectrum. Such materials may be described by transparency, translucence, chromaticity, monochromaticity, or polychromatic, as is known to those of ordinary skill in the art. The three-dimensional reconfigurable frameworks 100, 200, or 300 may be constructed in whole or in part using such materials.

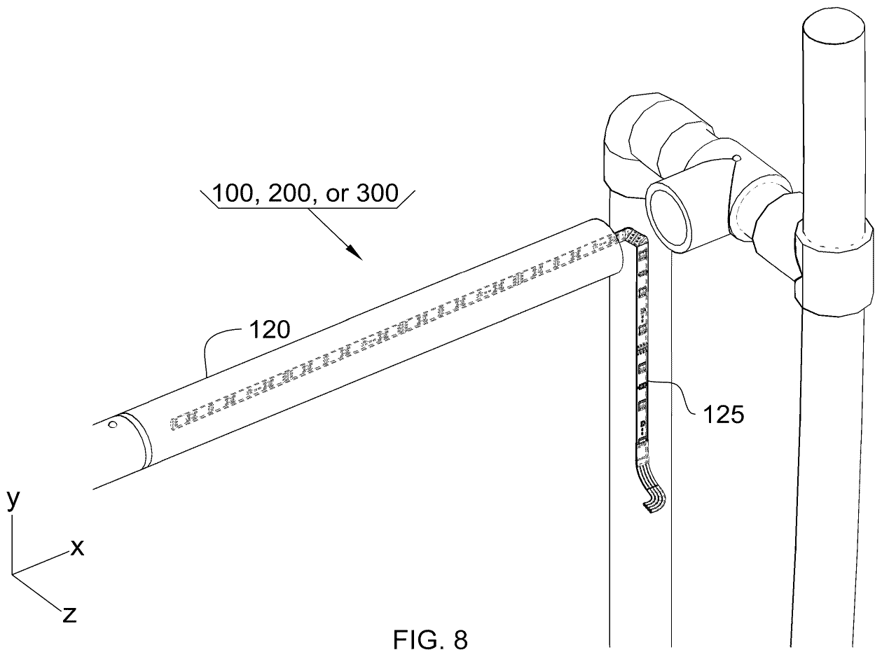

Turning now to FIG. 8, the three-dimensional reconfigurable frameworks 100, 200, or 300 may further comprise one or more arrays of illuminators 125 such that the one or more arrays of illuminators 125 are removably enclosed within the three-dimensional reconfigurable frameworks 100, 200, or 300.

The one or more arrays of illuminators 125 are selected from the group consisting of monochromatic illuminators, polychromatic illuminators, and sequentially arranged combinations thereof. The one or more arrays of illuminators 125 may include one or more of a variety of illuminator sources that are known to those of ordinary skill the art. Exemplary illuminator sources include incandescent, fluorescent, tungsten-halogen, light emitting diodes, high-intensity discharge, and equivalent light sources. The one or more arrays of illuminators 125 may be arranged in arrays of one or more columns, rows, or both columns and rows. The one or more arrays of illuminators 125 may further include illuminator support structures (not shown) that maintain the relative positioning of groups of the one or more arrays of illuminators 125 and/or facilitate insertion, removal, or mounting attachment of the one or more arrays of illuminators 125 to housings or external structures.

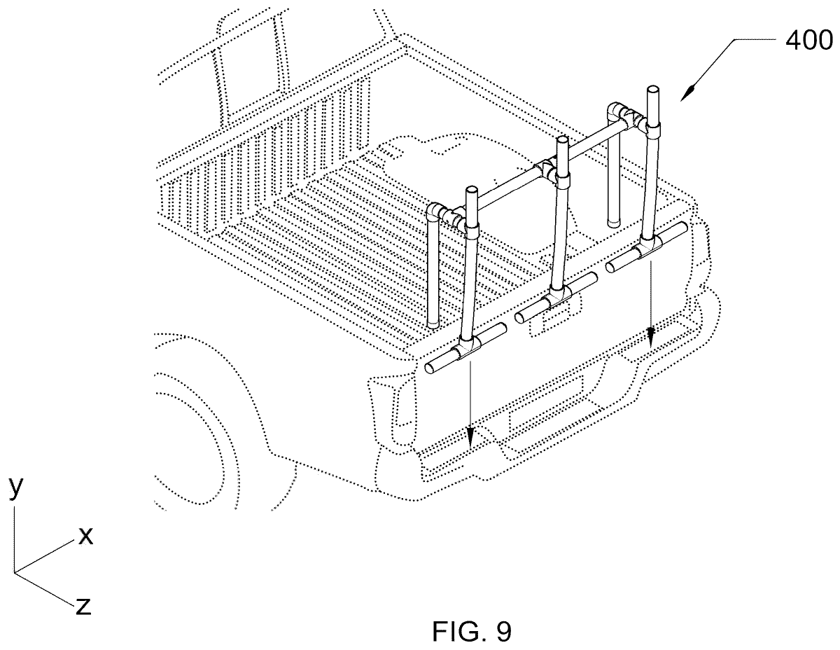

Turning now to FIG. 9 is shown a three-dimensional reconfigurable vehicle mounting system 400. The three-dimensional reconfigurable vehicle mounting system 400 may include any of the embodiments of the three-dimensional reconfigurable frameworks 100, 200, or 300.

As used herein, a vehicle may be any one of an automobile, a truck, a bus, a bicycle, a boat, a cab, a car, a jeep, a taxi, a van, a wagon, or any other vehicle having appropriate rear structural characteristics for receiving the three-dimensional reconfigurable frameworks 100, 200, or 300 by suspension over the rear structural components of the vehicle.

As used herein, a tailgate is a gate, door, or door-like component arranged at the rear of a vehicle that can be opened, closed, removed, or let down. A tailgate may also include securement features wherein the tailgate may be locked in an open, closed, or let down position.

As shown in FIG. 9, the three-dimensional reconfigurable vehicle mounting system 400 is constructed such that in a first position, the three-dimensional reconfigurable vehicle mounting system 400 is removably suspended over the tailgate of a vehicle. In the first position, the first group A column supports 110 and the second group A column supports 110 are arranged adjacent to one face of the tailgate of a vehicle and the at least one group B arcuate column supports 150 is suspended adjacent to an opposite face of the tailgate of a vehicle. Therefore, in the first position the first group A column supports 110 and the second group A column supports 110 are arranged inside of a vehicle, e.g., the flat bed portion of a vehicle, and are positioned behind a face of the tailgate of a vehicle. Moreover, in the first position the at least one group B arcuate column supports 150 are arranged outside of a vehicle, e.g. the flat bed portion of a vehicle, and are positioned in front of an opposite face of the tailgate of a vehicle. In this first position arrangement, the at least one group B arcuate column supports 150 may thus be supported by resting upon a rear bumper portion of a vehicle, outside of the vehicle.

In operation, the three-dimensional reconfigurable vehicle mounting system 400 that may include any of the embodiments of the three-dimensional reconfigurable frameworks 100, 200, or 300 further includes the at least one movable attachment mechanism 160 that is arranged to vary the radial separation distance R between the at least one group C row supports 120 and the at least one group D row supports 180 as the arc angle θ varies in a range from about 2 degrees to about 60 degrees. As a result, a height dimension of the three-dimensional reconfigurable vehicle mounting system 400 is variable along at least a Y axis and a width dimension of the three-dimensional reconfigurable vehicle mounting system 400 is simultaneously variable along at least a Z axis as the arc angle θ varies. Therefore the three-dimensional reconfigurable vehicle mounting system 400 is simultaneously variable along at least two orthogonal dimensions.

The three-dimensional reconfigurable vehicle mounting system 400 that is simultaneously variable along at least two orthogonal dimensions may be suspended over a tailgate of a vehicle is thus dimensionally adjustable in order to accommodate a plurality of vehicle tailgate form factors. As is known in the art, different types of vehicles may have a variety of different vehicle tailgate form factors which may vary in height, width, or depth dimensions. The three-dimensional reconfigurable vehicle mounting system 400 that is simultaneously variable along at least two orthogonal dimensions may be therefore used with a variety of different types of vehicles while accommodating a plurality of different vehicle tailgate form factors.

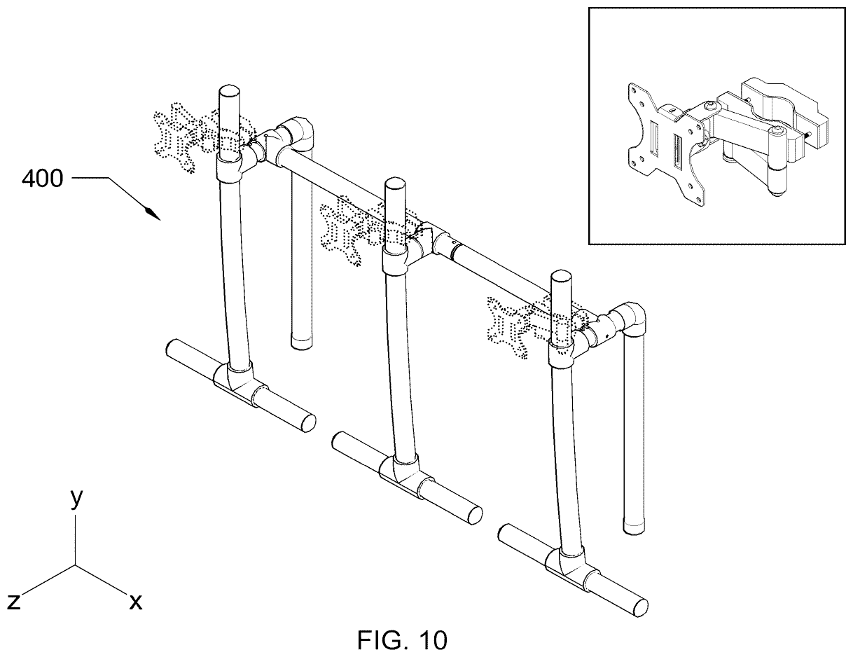

Referring now to FIG. 10, the three-dimensional reconfigurable vehicle mounting system 400 includes a second end portion of the at least one group B arcuate column supports 150 that is formed to receive one or a plurality of mounting brackets. The mounting brackets may be any of a variety of mounting brackets that are capable of attachment to a second end portion of the at least one group B arcuate column supports 150. The mounting brackets allow secure and convenient attachment of various devices to the three-dimensional reconfigurable vehicle mounting system 400. The mounting brackets are constructed to allow for translation along the X, Y, and Z axes, and rotational motion, e.g. roll, pitch, and yaw, for up to six degrees of freedom of the attached devices.

Exemplary attachable devices include electronic devices such as televisions, monitors, screens, cameras, video equipment, recording devices, speakers, microphones, computers, broadcast equipment, radio equipment, telephone equipment, transceivers, audio sources, amplifiers, light fixtures, spotlights, flood lights, area lighting, and the like.

Therefore, the attached electronic devices that are attached to the one or a plurality of mounting brackets that are mounted on the three-dimensional reconfigurable vehicle mounting system 400, including any of the embodiments of the three-dimensional reconfigurable frameworks 100, 200, or 300, are supported by the three-dimensional reconfigurable vehicle mounting system 400 and are movably positionable by repositioning mounting brackets along any of the six degrees of freedom of translation and rotation.

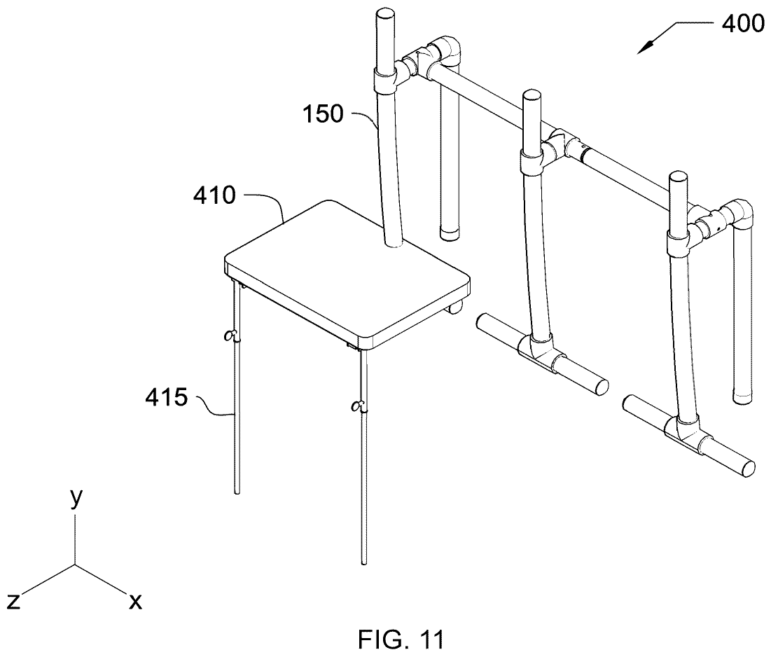

Turning now to FIG. 11 is shown another view of a three-dimensional reconfigurable vehicle mounting system 400 formed to receive tables 410 in accordance with an exemplary embodiment.

In FIG. 11, the three-dimensional reconfigurable vehicle mounting system 400 includes one or more tables 410 wherein the one or more tables 410 are formed for attachment to at least one group B arcuate column supports 150. As shown, the one or more tables 410 may further include one or more extensible legs 415. In an extended position, the one or more extensible legs 415 may directly rest upon a segment of earth terrain.

For clarity of explanation, the above description has focused on a representative sample of all possible embodiments, a sample that teaches the principles of the invention and conveys the best mode contemplated for carrying it out. The invention is not limited to the described embodiments. Well known features may not have been described in detail to avoid unnecessarily obscuring the principles relevant to the claimed invention. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus, methods, or systems described. Many of those undescribed alternatives, variations, modifications, and equivalents are within the literal scope of the following claims, and others are equivalent. The claims may be practiced without some or all of the specific details described in the specification.

Therefore, while the present invention has been illustrated by the description of exemplary embodiments thereof, and while the embodiments have been described in certain detail, there is no intention to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the general inventive concept.

### COPYRIGHT

A portion of the disclosure of this patent document contains material that is protected by copyright. The copyright owner has no objection to the facsimile reproduction of the patent document or the patent disclosure as it appears in the Patent and Trademark Office file or records, but otherwise reserves all copyright rights whatsoever.

1. A three-dimensional reconfigurable framework comprising:
a first group A column support; and
a second group A column support; and
at least one group C row support; and
at least one coupling element;
wherein the first group A column support is rotatively connected to at least one coupling element; and
the second group A column support is rotatively connected to at least one coupling element; and
the at least one group C row support is removably connected to both the first group A column support and the second group A column support via at least one coupling element; and
at least one group B arcuate column support; and
at least one movable attachment mechanism; and
the at least one group B arcuate column support cooperates with the at least one group C row support via at least one coupling element; and
at least one group D row support; and
the at least one group D row support is removably connected via at least one coupling element to the at least one group B arcuate column support;
wherein each of the first group A column support, the second group A column support, the at least one group C row support, the at least one coupling elements, the at least one group B arcuate column support, and the at least one group D row support are rotatively interconnected to form a three-dimensional reconfigurable framework having at least a first position and a second position; and
wherein in a first position the first group A column support and the second group A column support are both securely rotated into a mutually orthogonal arrangement with respect to the at least one group C row support; and
in a second position the first group A column support and the second group A column support are both securely rotated into a mutually parallel arrangement with respect to the at least one group C row support; and
in the first position the at least one group B arcuate column support is arcuate along a longest axis having an arc angle θ, wherein θ is in a range from 2 degrees to about 60 degrees between a first end portion of the at least one group B arcuate column support and a second end portion of the at least one group B arcuate column support; and
the first end portion of the at least one group B arcuate column support is orthogonal with respect to at least one group D row support; and
the second end portion of the at least one group B arcuate column support is movably attached to the at least one group C row support through the at least one movable attachment mechanism; and
wherein the at least one movable attachment mechanism is arranged to vary a radial separation distance R between the at least one group C row support and the at least one group D row support.

2. The three-dimensional reconfigurable framework of claim 1 wherein the at least one movable attachment mechanism is slidably attached along the longest axis of the at least one group B arcuate column support such that the at least one movable attachment mechanism is bidirectionally movable, at least in part, along a surface the second end portion of the at least one group B arcuate column support.

3. The three-dimensional reconfigurable framework of claim 1 wherein the three-dimensional reconfigurable framework further comprises a plurality of group B arcuate column supports each arcuate along respective longest axes and having arc angles θ, and a plurality of movable attachment mechanisms.

4. The three-dimensional reconfigurable framework of claim 1, wherein in the first position the first group A column support and the second group A column support are both securely rotatable by release of a manipulable locking mechanism; and in the second position the first group A column support and the second group A column support are both securely held in position by engagement of the manipulable locking mechanism.

5. The three-dimensional reconfigurable framework of claim 1, wherein the first group A column support and the second group A column support further comprise telescoping columns and feet.

6. The three-dimensional reconfigurable framework of claim 1, wherein the three-dimensional reconfigurable framework is constructed, at least in part, from materials having transmittance in the visible light spectrum characterized by transparency, translucence, chromaticity, monochromaticity, or polychromatic.

7. The three-dimensional reconfigurable framework of claim 6, wherein the three-dimensional reconfigurable framework further comprises one or more arrays of illuminators such that the one or more arrays of illuminators are removably enclosed within the three-dimensional reconfigurable framework.

8. The three-dimensional reconfigurable framework of claim 7, wherein the one or more arrays of illuminators are selected from the group consisting of monochromatic illuminators, polychromatic illuminators, and sequentially arranged combinations thereof.

9. A three-dimensional reconfigurable vehicle mounting system comprising:
a first group A column support; and
a second group A column support; and
at least one group C row support; and
at least one coupling element;
wherein the first group A column support is rotatively connected to at least one coupling element; and
the second group A column support is rotatively connected to at least one coupling element; and
the at least one group C row support is removably connected to both the first group A column support and the second group A column support via at least one coupling element; and
at least one group B arcuate column support; and
at least one movable attachment mechanism; and
the at least one group B arcuate column support cooperates with the at least one group C row support via at least one coupling element; and
at least one group D row support; and
the at least one group D row support is removably connected via at least one coupling element to the at least one group B arcuate column support;
wherein each of the first group A column support, the second group A column support, the at least one group C row support, the at least one coupling elements, the at least one group B arcuate column support, and the at least one group D row support are rotatively interconnected to form a three-dimensional reconfigurable vehicle mounting system having at least a first position and a second position; and
wherein in a first position the first group A column support and the second group A column support are both securely rotated into a mutually orthogonal arrangement with respect to the at least one group C row support; and
in a second position the first group A column support and the second group A column support are both securely rotated into a mutually parallel arrangement with respect to the at least one group C row support; and
in the first position the at least one group B arcuate column support is arcuate along a longest axis having an arc angle θ, wherein θ is in a range from 2 degrees to about 60 degrees between a first end portion of the at least one group B arcuate column support and a second end portion of the at least one group B arcuate column support; and
the first end portion of the at least one group B arcuate column support is orthogonal with respect to at least one group D row support; and
the second end portion of the at least one group B arcuate column support is movably attached to the at least one group C row support through the at least one movable attachment mechanism; and
wherein the at least one movable attachment mechanism is arranged to vary a radial separation distance R between the at least one group C row support and the at least one group D row support; and
wherein in the first position the three-dimensional reconfigurable vehicle mounting system is removably suspended over the tailgate of a vehicle, such that the first group A column support and the second group A column support are arranged adjacent to one face of the tailgate of a vehicle and the at least one group B arcuate column support is suspended adjacent to an opposite face of the tailgate of a vehicle.

10. The three-dimensional reconfigurable vehicle mounting system of claim 9 wherein the at least one movable attachment mechanism is slidably attached along the longest axis of the at least one group B arcuate column support such that the at least one movable attachment mechanism is bidirectionally movable, at least in part, along a surface the second end portion of the at least one group B arcuate column support.

11. The three-dimensional reconfigurable vehicle mounting system of claim 9 wherein the three-dimensional reconfigurable vehicle mounting system further comprises a plurality of group B arcuate column supports each arcuate along respective longest axes and having arc angles θ, and a plurality of movable attachment mechanisms.

12. The three-dimensional reconfigurable vehicle mounting system of claim 9, wherein in the first position the first group A column support and the second group A column support are both securely rotatable by release of a manipulable locking mechanism; and in the second position the first group A column support and the second group A column support are both securely held in position by engagement of the manipulable locking mechanism.

13. The three-dimensional reconfigurable vehicle mounting system of claim 9, wherein the first group A column support and the second group A column support further comprise telescoping columns and feet.

14. The three-dimensional reconfigurable vehicle mounting system of claim 9, wherein the three-dimensional reconfigurable vehicle mounting system is constructed, at least in part, from materials having transmittance in the visible light spectrum characterized by transparency, translucence, chromaticity, monochromaticity, or polychromatic.

15. The three-dimensional reconfigurable vehicle mounting system of claim 14, wherein the three-dimensional reconfigurable vehicle mounting system further comprises one or more arrays of illuminators such that the one or more arrays of illuminators are removably enclosed within the three-dimensional reconfigurable vehicle mounting system.

16. The three-dimensional reconfigurable vehicle mounting system of claim 15, wherein the one or more arrays of illuminators are selected from the group consisting of monochromatic illuminators, polychromatic illuminators, and sequentially arranged combinations thereof.

17. The three-dimensional reconfigurable vehicle mounting system of claim 9, wherein in the first position at least one length of the three-dimensional reconfigurable vehicle mounting system suspended over the tailgate of a vehicle is adjustable to accommodate a plurality of vehicle tailgate form factors.

18. The three-dimensional reconfigurable vehicle mounting system of claim 9, wherein the second end portion of the at least one group B arcuate column support is formed to receive a mounting bracket.

19. The three-dimensional reconfigurable vehicle mounting system of claim 9, wherein one or more tables are formed for attachment to at least one group B arcuate column supports.
